(19) United States
(12) Patent Application Publication
(10) Pub. No.: US 2004/0063838 A1
(43) Pub. Date: Apr. 1, 2004

(54) Method of producing flame-retardant plastics

(76) Inventor: Rene Herbiet, Eupen (BE)

Correspondence Address: MANELLI DENISON & SELTER, 2000 M STREET NW SUITE 700, WASHINGTON, DC, 20036-3307, US

(21) Appl. No.: 10/466,813

(22) PCT Filed: Jan. 28, 2002
(86) PCT No.: PCT/EP02/00843

(30) Foreign Application Priority Data
Jan. 26, 2001 (EP) 01101795.1

(51) Int. Cl. C08K 3/10; C08K 5/09

(52) U.S. Cl. 524/436; 524/437; 524/300

(57) ABSTRACT

A cost-favourable process for the preparation of filled halogen-free self-extinguishing polymer compounds (HFFR compounds) based on halogen-free flame-retardant aluminium- or magnesium-hydroxide-containing fillers by an in-situ filler modification is described.

### DESCRIPTION

The invention relates to a compounding process for the preparation of self-extinguishing polymer compounds based on halogen-free flame-retardant fillers.

Halogen-free flame-retardant fillers such as e.g. magnesium or aluminium hydroxide are coated on the filler surface for the purpose of optimal incorporation into polymers and to improve the compound properties. This is carried out e.g. with salts of fatty acids according to DE-PS 26 59 933 or e.g. with acid-group-containing polymers according to EP-A 92 233.

It was able to be shown (WO 96/26240) that the use of fatty-acid derivatives and polysiloxanes in the surface treatment of fillers as compatibility agents between fillers and polymer matrix results in improved material properties. Furthermore, the use of the named compatibility agents allows the use of more economical, natural or synthetic fillers with higher property tolerances. The price advantage gained by the use of cheaper filler material is however partially or completely offset again by the separate expensive coating step. As a result of the expensive separate work steps of coating and subsequent compounding, a wide use of the thus-produced high-quality compounds was often impossible, in particular in the lower price segment.

This led to the object of finding a cost-favourable alternative, also for mass-produced articles (but not only for these), to replace halogen-containing or phosphorus-containing flame-retardant compounds with a cheaper process for the modification of halogen-free flame-retardant fillers with compatibility-promoting additives.

Surprisingly this object could be achieved with a process according to claim 1 by an in-situ compounding of polymers with, at the time of incorporation, non-surface-modified fillers and compatibility-promoting additives.

Contrary to the expectation that with this process only a disproportionate increase of the quantity of compatibility-promoting additives would lead to a satisfactory flameproofing effect with similar rheological and mechanical material properties as with the separate coating of the fillers, it has been shown that with the in-situ compounding, even with identical added quantities of the compatibility-promoting additives, in addition to a clear reduction in costs, in part even better material properties of the thus-obtained self-extinguishing compounds can be achieved.

The in-situ compounding process according to the invention with halogen-free flame-retardant fillers and compatibility-promoting additives is preferably suitable for the flameproof finishing of thermoplastic or cross-linkable polyolefins, thermoplastic elastomers and rubber compounds. Some examples are polyethylene and its copolymers, polypropylene and its copolymers, polyamides, aliphatic polyketones or ethylene propylene diene terpolymers (EPDM) and styrene butadiene rubber (SBR).

Suitable hydroxides of magnesium for an effective flameproof finish are e.g. natural Mg(OH)₂ types such as e.g. brucite or sea-water types, natural magnesium hydroxy carbonates such as e.g. huntite or hydromagnesite, or synthetic magnesium hydroxides as sold e.g. under the trademark MAGNIFIN® by Martinswerk GmbH. Magnesium hydroxides are used as a flameproof finish preferably in the high-temperature range, i.e. in polymers which can be processed up to approx. 340° C., preferably in thermoplastic or cross-linkable polyolefins, thermoplastic elastomers and rubber compounds.

Suitable hydroxides of aluminium are e.g. natural Al(OH)₃-containing materials such as e.g. hydrargillite or gibbsite, (Al₂O₃.x H₂O)-containing materials (with x<3) such as e.g. boehmite or synthetic aluminium hydroxides as sold e.g. under the trademark MARTIFIN® or MARTINAL® by Martinswerk GmbH in Bergheim (Germany). The hydroxides of aluminium are expediently used in compounds in particular with thermoplastic or cross-linkable polyolefins such as e.g. polyethylene, its copolymers such as e.g. ethylene vinyl acetate copolymers (EVA) or also rubber mixtures, which can be processed up to approx. 200° C.

Depending on the required property profile of the filled polymer, the named hydroxides of aluminium and/or hydroxides of magnesium can be used alone or in any mixture ratios, and also with the admixing of one or more oxides of aluminium, magnesium, titanium or zirconium or with further filler materials, such as e.g. calcium carbonate, talc or calcinated or non-calcinated clays, in order to control e.g. abrasion behaviour, hardness or weathering behaviour. The named oxides can be used in the quality customary in the trade.

The level of filler in the relevant polymer matrix varies, independent of the desired degree of flameproofing, as a rule between 5 wt.-% and 90 wt.-% of the compound, preferably between 20 wt.-% and 70 wt.-% of the compound.

According to the invention, the in-situ compounding of the halogen-free flame-retardant filler takes place in a variant with a fatty-acid derivative from the group of the polymer fatty acids, the keto fatty acids, the fatty alkyl oxazolines or bisoxazolines and optionally a siloxane derivative, or in another variant with a fatty acid and a siloxane derivative. By polymer fatty acids are meant compounds prepared by oligomerization such as e.g. by di- or trimerisation of corresponding fatty acids. Suitable representatives are e.g. polystearic acid, polylauric acid or polydecanoic acid (Henkel Referate 28, 1992, p. 39 ff).

By keto fatty acids are meant keto-group-containing fatty acids with preferably 10 to 30 C atoms. A preferred representative of a keto fatty acid is ketostearic acid (Henkel Referate 28, 1992, p. 34 ff).

By fatty alkyl oxazolines are meant alkyl or hydroxyalkyl-substituted oxazolines in position 2. The alkyl group preferably has 7 to 21 C atoms. Bisoxazolines are compounds which are syntheticized from hydroxyalkyloxazolines by reaction with diisocyanates. A preferred representative is e.g. 2-undecyl-oxazoline (Henkel Referate 28, 1992, p. 43 ff).

In the following explanations, quantity details are given in parts parts per weight.

The named fatty-acid derivatives are used either individually or in combination in a quantity of 0.01 to 10 parts, preferably 0.05 to 5 parts, per 100 parts filler.

By a fatty acid is meant with the second variant either a saturated or unsaturated natural fatty acid with preferably 10 to 30 C atoms, a mono- or polyunsaturated hydroxy fatty acid with preferably 10 to 30 C atoms such as e.g. hydroxynervonic acid or ricinoleic acid or a saturated hydroxy fatty acid such as e.g. hydroxystearic acid or a derivative of the previous compounds. Suitable natural fatty acids are e.g. stearic acid, lauric acid, myristic acid, palmitic acid, oleic acid or linoleic acid. Fatty-acid salts or modified fatty acids such as e.g. stearic acid glycidyl methacrylate can be used as fatty-acid derivatives. Saturated fatty acids or hydroxy fatty acids or derivatives thereof are preferably used.

The named fatty acids can be used either individually or in combination in a quantity of 0.01 to 10 parts, preferably from 0.05 to 5 parts, per 100 parts filler.

In the variant with fatty acids, the siloxane component is absolutely necessary to achieve the required property profile.

The added quantity of the siloxane component is 0.01 to 20 parts, preferably 0.05 to 10 parts, per 100 parts filler.

Suitable siloxane derivatives are oligoalkyl siloxanes, polydialkyl siloxanes such as e.g. polydimethyl siloxane, polydiethyl siloxane, polyalkylaryl siloxanes such as e.g. polyphenylmethyl siloxane or polydiaryl siloxanes such as e.g. polyphenyl siloxane.

The named siloxanes can be functionalized with reactive groups such as e.g. hydroxy, amino, vinyl, acryl, methacryl, carboxy or glycidyl groups.

High-molecular polydialkyl siloxanes, which have optionally been functionalized with the named groups, are preferably used as siloxane derivatives.

To prepare particularly economical compounds, in a preferred version of the halogen-free flame-retardant filler, up to a quantity of 70 wt.-% filler, preferably up to a quantity of 50 wt.-% filler, can be replaced by calcium carbonate, accompanied by a reduction in the flameproofing effect.

The compatibility-promoting additives which are present partly in liquid aggregate state, can be used for example together with carrier materials such as pyrogenic silicic acid or precipitation silicic acid.

Preferred pyrogenic silicic acids are Aerosil® types from Degussa. Preferred precipitation silicic acids are Sipernat® types from Degussa.

The named carrier materials can be used independent of the compatibility-promoting additive in a quantity of 0.1 to 10 parts per 100 parts filler.

The filled compounds obtained according to patent claim 1 can also contain fibrous reinforcing agents.

The fibrous materials include for example glass fibres, stone fibres, metal fibres, polycrystalline ceramic fibres, including the monocrystals, the so-called “whiskers” and likewise all fibres stemming from synthetic polymers such as e.g. aramide, carbon, polyamide, polyacrylic and polyester fibres.

If desired, the compounds can be provided with suitable pigments and/or colorants and/or with further application-specific additives or auxiliaries such as e.g. polyethylene waxes, or also stabilizers for stabilizing the plastic system or mixtures thereof.

Furthermore, cross-linkers such as e.g. triallyl cyanurate and/or peroxides can be added if the compound is to be cross-linked in a further processing step.

For in-situ compounding, the unfilled polymer, together with the untreated halogen-free flame-retardant filler, is expediently provided with the mentioned additives in a suitable mixer, preferably in a mixer with high shear forces. The addition can take place in a chosen sequence at specific time intervals at different temperatures and using process parameters adapted to the additives. It is likewise possible to feed the mixer with a premix of the additives together with the halogen-free flame-retardant fillers.

In a preferred version, the compounding is carried out in a kneader such as e.g. GK E 5 with an interlocking rotor system from the company Werner & Pfleiderer.

In a further preferred version, the compounding is carried out on a heatable rolling mill, e.g. from the company Collin, type W150M. The untreated fillers with the compatibility-promoting additives and optionally further aggregates are added to the polymer which was previously melted on the rolling mill. The addition in chosen sequence can take place at specific time intervals at different temperatures and using process parameters adapted to the additives.

As further compounding aggregates there can be used for the process according to the invention further mixed aggregates customary in the trade such as e.g. twin-screw extruders or cokneaders as manufactured for example by the company Buss Compounding Systems AG (Prattein, Switzerland) or so-called continuous mixers as sold for example by the company Farrel (Ansonia, Connecticut, U.S.A.).

### EXAMPLES

In the application examples, phr denotes parts by weight per 100 parts by weight polymer.

### Example VI

### Comparison

150 phr uncoated magnesium hydroxide filler (MDH) MAGNIFIN® H 5 (Martinswerk GmbH) were processed to form a compound with 100 phr ethylene/vinyl acetate polymer (EVA) Escorene Ultra® UL00119 (EVA, 19 wt.-% VA copolymer, Exxon) in a kneader GK 5 E (Werner & Pfleiderer), rotational speed 50 rpm, cooling-water temperature 50° C., machine fill level 75%) in situ with addition of 0.4 phr antioxidant Irganoxe 1010 (Ciba). The mixture was discharged at a compound temperature of 180° C.

### Example V2

### Comparison

As described in WO 96/26240, 10 kg MDH filler MAGNIFIN® H5 were coated in the Henschel mixer with the fatty-acid mixture Pristerenee 4900 (1.5 wt.-% relative to the filler, Unichema Chemie) and silicone oil AK150 (0.3 wt.-% relative to the filler, Wacker Chemie).

150 phr of thus-coated MDH filler were processed to form a compound with 100 phr Escorene Ultra® UL00119 and 0.4 phr Irganoxe 1010 as in Example V1. The mixture was discharged at a compound temperature of 180° C.

### Example 1

150 phr uncoated MDH filler MAGNIFIN® H5 were processed to form a compound with 100 phr Escorene Ultra® UL00119 in situ with the addition of 0.4 phr Irganox® 1010, silicone oil AK150 (0.3 wt.-% relative to the filler) and Pristerene®4900 (1.5 wt.-% relative to the filler) in the kneader as in Example V1. The mixture was discharged at a compound temperature of 180° C.

### Example 2

80 phr Escorene Ultra® UL00328 (EVA, 27 wt.-% VA copolymer, EXXON) and 20 phr mLLDPE ML2518FL (Exxon) were compounded in situ on a rolling mill at a roll temperature of 130° C. with 150 phr uncoated aluminium hydroxide filler (ATH) MARTINAL® ON4608 (Martinswerk GmbH), silicone oil AK150 (0.5 wt.-% relative to the filler), Pristerene® 4912 (2.5 wt.-% relative to the filler, Unichema Chemie) and 0.5 phr Irganox® 1010. First, the polymer system was melted on the roll until a sheet had formed. The uncoated filler and the additives were then added. The compounding time was 35 minutes.

### Example V3

### Comparison

As described in WO 96/26240, 10 kg uncoated ATH filler MARTINAL® ON4608 were coated in the Henschel mixer with Pristerene®4912 (2.5 wt.-% relative to the filler) and silicone oil AK150 (0.5 wt.-% relative to the filler).

150 phr of thus-coated ATH filler were compounded on a rolling mill with 80 phr Escorene Ultra® UL00328 and 20 phr mLLDPE ML2518FL at a roll temperature of 130° C. First, the polymer system was melted on the roll until a sheet formed. The coated filler and 0.5 phr Irganoxe 1010 were then added. The compounding time was 35 minutes.

### Example V4

### Comparison

186 phr uncoated MDH filler (MDH) MAGNIFIN® H5 and 100 phr Novolen® 3200H (BASELL) were compounded on a rolling mill at a roll temperature of 175° C. First, the polymer was melted on the roll until a sheet formed. The uncoated filler was then added. The compounding time was 35 minutes.

### Example 3

186 phr uncoated MDH filler MAGNIFIN® H5 and 100 phr Novolen® 3200H were compounded in situ with the addition of silicone oil AK150 (0.5 wt.-% relative to the filler) and Pristerene® 4912 (1.0 wt.-% relative to the filler) on a rolling mill at a roll temperature of 175° C. First, the polymer was melted on the roll until a sheet formed. The uncoated filler and the coating agents were then added. The compounding time was 35 minutes.

### Example V5

### Comparison

10 kg MDH filler MAGNIFIN® H5, as described in WO 96/26240, were coated in the Henschel mixer with Pristerene® 4912 (1.0 wt.-% relative to the filler) and silicone oil AK150 (0.5 wt.-% relative to the filler).

186 phr of thus-coated MDH filler was compounded on a rolling mill with 100 phr Novolen® 3200H at a roll temperature of 175° C. First, the polymer system was melted on the roll until a sheet formed. The coated filler was then added. The compounding time was 35 minutes.

The test results of the examined parameters of the application examples are shown in Table 1.

TABLE 1

| | |
|---|---|
| Legends to the table and the measurement methods: | |
| Tensile strength/elongation at break on extruded | according to DIN 53 455 |
| testpieces for the polypropylene compounds | |
| Tensile strength/elongation at break on extruded | according to DIN 53 504 |
| punched testpieces for the EVA compounds | |
| Melt flow index (MFI) | according to DIN 53 735 |
| Specific resistance | according to DIN 53 482 |
| n.m. | not measured |

| | | | MFI | Spec. resistance |
|---|---|---|---|---|
| | Tensile strength | Elongation at break | (190° C./10 kg) | (28 d in 50° C. H₂O) |
| Example | [N/mm²] | % | [g/10 min] | [Ω · cm] |
| V1 | 11 | 140 | 1.1 | 3.0 · 10¹² |
| V2 | 8.3 | 470 | 3.8 | 8.9 · 10¹⁴ |
| 1 | 9.7 | 520 | 4.1 | 6.3 · 10¹⁴ |
| 2 | 3.2 | 390 | n.m. | n.m. |
| V3 | 3.5 | 409 | n.m. | n.m. |
| V4 | 20.2 | 1.5 | not measurable at | n.m. |
| | | | 230° C./5 kg | |
| 3 | 13.3 | 234 | 7.4 at 230° C./5 kg | n.m. |
| V5 | 14.5 | 180 | 7.2 at 230° C./5 kg | n.m. |

1. Process for the preparation of filled flame-retardant thermoplastic or cross-linkable polyolefins or thermoplastic industrial plastics or thermoplastic elastomers or rubber mixtures, containing
a) at least one thermoplastic or cross-linkable polymer or a thermoplastic elastomer,
b) at least one halogen-free flame-retardant aluminium- or magnesium-hydroxide-containing filler in a quantity of 5 wt.-% to 90 wt.-%,
c) a compatibility-promoting additive, composed of
i) at least one fatty-acid derivative from the group of the polymer fatty acids, the keto fatty acids, the fatty alkyl oxazolines or bisoxazolines in a quantity of 0.01 to 10 parts per 100 parts halogen-free flame-retardant filler and optionally a siloxane derivative in a quantity of 0.01 to 20 parts per 100 parts halogen-free flame-retardant filler and/or
ii) at least one fatty acid in a quantity of 0.01 to 10 parts per 100 parts halogen-free flame-retardant filler and a siloxane derivative in a quantity from 0.01 to 20 parts per 100 parts halogen-free flame-retardant filler,
characterized in that the polymer (a) is processed in situ to a flame-retardant compound with the filler (b) without prior surface modification and the compatibility-promoting additive (c).

2. Process according to claim 1, characterized in that synthetic magnesium- or aluminium hydroxides or natural magnesium- or aluminium-hydroxide-containing minerals or natural magnesium hydroxides or natural magnesium hydroxy carbonates or any mixtures thereof are used as uncoated halogen-free flame-retardant filler.

3. Process according to claim 1 or 2, characterized in that the halogen-free flame-retardant filler is replaced by calcium carbonate up to a quantity of 70 wt.-% filler.

4. Process according to one of claims 1 to 3, characterized in that the individual components are compounded in a kneader.

5. Process according to one of claims 1 to 3, characterized in that the individual components are compounded on a rolling mill after melting of the polymer or polymer system directly on the roll.

6. Process according to one of claims 1 to 3, characterized in that the compounding is carried out in a cokneader.

7. Process according to one of claims 1 to 3, characterized in that compounding is carried out in a twin-screw extruder.

8. Process according to one of claims 1 to 3, characterized in that compounding is carried out in a continuous mixer.
